(19) United States
(12) Patent Application Publication
(10) Pub. No.: US 2023/0091439 A1
(43) Pub. Date: Mar. 23, 2023

(54) PROCESS FOR PREPARING ISOCYANATE-BASED STABLE DISPERSIONS COMPRISING DERIVATIZED POLYSACCHARIDES

(71) Applicant: Huntsman International LLC, The Woodlands, TX (US)

(72) Inventors: Christopher Phanopoulos, Tervuren (BE); Tugba Vardareli, Wezembeek Oppem (BE)

(21) Appl. No.: 17/908,936

(22) PCT Filed: Feb. 26, 2021
(86) PCT No.: PCT/EP2021/054910

§ 371 Date: Sep. 2, 2022

(30) Foreign Application Priority Data
Mar. 3, 2020 (EP) 20160622.5

(51) Int. Cl. C08G 18/08; C08B 15/06; C08G 18/64; C08G 18/76; C08G 18/10

(52) U.S. Cl. CPC C08G 18/0871; C08B 15/06; C08G 18/6484; C08G 18/7671; C08G 18/10

(57) ABSTRACT

The invention relates to a process for preparing a derivatized polysaccharide and stable isocyanate-based dispersions comprising derivatized polysaccharide.

### FIELD OF THE INVENTION

The present invention relates to processes for preparing derivatized polysaccharide and to stable dispersions comprising the derivatized polysaccharide in isocyanate-based liquids and products obtained using said stable dispersions.

### BACKGROUND OF THE INVENTION

Cellulose is a fibrous, tough, water-insoluble substance which can be found in the cell wall of plants. It is a polysaccharide that is mainly composed of [beta]-D-gluco-pyranose units linked by 1→4 glycosidic bonds. From a structural perspective, cellulosic chains are arranged into microfibrils during crystallization with the formation of chain-stiffening inter-molecular hydrogen bonds. Different crystalline allomorphs of cellulose are known.

To improve the (mechanical) properties of polyurethane materials, cellulose (and polysaccharides in general) are attractive filler materials. However, cellulose is not compatible with isocyanate-based liquids and it is very difficult to make stable dispersions of cellulosic materials in isocyanate-based liquids. Derivatization of the cellulose (polysaccharides) beforehand is therefore required.

The hydroxyl groups in cellulose are involved in a number of intra- and intermolecular hydrogen bonds and generally show limited reactivity. As a consequence, chemical derivatization of these hydroxyl groups is extremely difficult. Even towards highly reactive molecules (such as e.g. isocyanates), these hydroxyl groups show no or very little reactivity. Another disadvantage of these cellulosic materials is their high melting point, usually higher than the thermal decomposition temperature, which limits their derivatization potential in liquid phase.

Traditional approaches in chemical derivatization of cellulose make use of chemically and/or physically harsh conditions (chemicals, temperature, pressure, pH, . . . ) to dissolve or derivatize cellulose. This impacts the bulk structure and related properties (such as crystallinity) of the substrates. These current solutions have mainly focused on decreasing or eliminating the hydrogen bonding pattern in the cellulosic substrate, as discussed below.

Sometimes, the problem is merely ignored. In these cases, the cellulose may act as a non-reactive ‘filler’.

One option is to alkoxylate the cellulosic substrate in order to increase its solubility and compatibility with the derivatization agent. Alkoxylation impacts crystallinity, adds costs and moreover, is associated with environmental, health and safety (EHS) risks.

Another possibility is the use of mono-, di- and/or oligosaccharides which possess different solubility characteristics. However, such use is limited in some applications when the bulk properties of the cellulosic substrates are required (e.g. composites).

Another option is to break down the hydrogen bonding network.

Frequently applied methods chemically digest the cellulosic substrates by sulfite or alkali processes (caustic soda, dilute NaOH) at elevated temperatures in pressure vessels (degradation, lower molecular weight, decreased crystallinity). However, the aqueous medium or residual moisture, which is often bound into the hydrogen network, is incompatible with isocyanate chemistry and causes side reactions. In addition, residues of the digesting medium (e.g. Na and/or K cations) can be released and can cause side reactions with isocyanates (e.g. isocyanurates). Furthermore, the degradation of the structure leads to a deterioration of the cellulosic properties.

The hydrogen bond network may also be partially or completely destroyed by using mechanical treatments (for example: grinding, milling, etc), wherein mechanical energy may tear apart the microfibrils in order to degrade the cellulosic substrate. This leads to a reduced molecular weight and higher amorphous content.

Alternatively, steam explosion can be applied to break down the cellulosic substrate in harsh pressure and temperature conditions.

EP2870181 discloses derivatization of a polysaccharide (e.g. cellulose) with a polyisocyanate (e.g. MDI) by using a swelling agent (solvent) in order to activate the hydroxyl groups in the polysaccharide and make them able to react with the polyisocyanate. However, this process has some disadvantages. In particular, after the derivatization process, the derivatized polysaccharide needs to be precipitated, filtered off, washed, dried at elevated temperatures and finally dispersed in polyurethane prepolymer of interest. This process hence requires long production times and high production cost to make the derivatized polysaccharide.

Therefore, there remains a need for processes for preparing derivatized polysaccharides that overcome one or more of the aforementioned issues.

### Object of the Invention

It is an object of the present invention to provide an improved process for derivatizing polysaccharide in order to make stable dispersions of polysaccharides in isocyanate-based liquids such as an isocyanate prepolymer.

### Definitions

Unless otherwise defined, all terms used in disclosing the invention, including technical and scientific terms, have the meaning as commonly understood by one of ordinary skill in the art to which this invention belongs. By means of further guidance, below term definitions are included to better appreciate the teaching of the present invention.
1) NCO value
   In the context of the present invention, the expression “NCO content” should be understood as the NCO value, which is defined as: The isocyanate content (NCOv) (also referred to as percent NCO or NCO content) of all isocyanate-bearing compounds, given in weight % and measured by conventional NCO titration following the standard DIN 53185. In brief, isocyanate is reacted with an excess of di-n-butylamine to form urea. The unreacted amine is then titrated with standard nitric acid to the color change of bromocresol green indicator or to a potentiometric endpoint. The percent NCO or NCO-value is defined as the percent by weight of NCO-groups present in the product. In the context of the present invention, the expression “NCO value” corresponds to an isocyanate value (also referred as isocyanate content or NCO content), which is the weight percentage of reactive isocyanate (NCO) groups in an isocyanate bearing compound and is determined using the following equation, where the molecular weight of the NCO group is 42:

$$Isocyanate value = wt \% NCO groups = \frac{42 ⨯ functionality}{molecular weight} ⨯ 100$$

2) isocyanate index or NCO index or index:
   the ratio of NCO-groups over isocyanate-reactive hydrogen atoms present in a formulation, given as a percentage:

$$\frac{[ moles NCO ] ⨯ 100}{[ moles active H atoms ]} \%$$

In other words the NCO-index expresses the percentage of isocyanate actually used in a formulation with respect to the amount of isocyanate theoretically required for reacting with the amount of isocyanate-reactive hydrogen used in a formulation.
It should be observed that the isocyanate index as used herein is considered from the point of view of the actual polymerisation process preparing the polyurethane material involving the isocyanate ingredient and the isocyanate-reactive ingredients. Any isocyanate groups consumed in a preliminary step to produce modified polyisocyanates (including such isocyanate-derivatives referred to in the art as prepolymers) or any active hydrogens consumed in a preliminary step (e.g. reacted with isocyanate to produce modified polyols or polyamines) are not taken into account in the calculation of the isocyanate index.
3) The expression “isocyanate-reactive hydrogen atoms” as used herein for the purpose of calculating the isocyanate index refers to the total of active hydrogen atoms in hydroxyl and amine groups present in the reactive compositions; this means that for the purpose of calculating the isocyanate index at the actual polymerisation process one hydroxyl group is considered to comprise one reactive hydrogen and one primary amine group is considered to comprise one reactive hydrogen.
4) The term “average nominal hydroxyl functionality” (or in short “functionality”) is used herein to indicate the number average functionality (number of hydroxyl groups per molecule) of the polyol or polyol composition on the assumption that this is the number average functionality (number of active hydrogen atoms per molecule) of the initiator(s) used in their preparation although in practice it will often be somewhat less because of some terminal unsaturation.
5) As used herein the terms “derivatized polysaccharide”, “polysaccharide derivative”, “modified polysaccharide” and “functionalized polysaccharide” are synonymous and used interchangeably and refer to an isocyanate functionalized polysaccharide. The reaction product may be obtained by adding, reacting, contacting or mixing the different components.
6) The term “prepolymer” and “isocyanate prepolymer” refers herein to reactive intermediates between monomeric isocyanates and fully reacted polyurethane or polyurea polymers. The prepolymers are isocyanate terminated polymers that contain polyurethane (or alternatively urea) linkages as well as reactive NCO groups which may further react with hydroxyl or amine groups to chain extend and further crosslink the prepolymers.
7) The term “dispersion” refers to a system in which distributed particles or granules of one material are dispersed in a continuous phase of another material. The two phases may be in the same or different states of matter. In this invention derivatized polysaccharide may present in an isocyanate-based liquid as a dispersion of derivatized polysaccharide particles in an isocyanate-based liquid.
8) The term “stable dispersion” refers to a dispersion wherein the distributed particles or granules remain as individual particles over time. By contrast, an unstable dispersion will show coagulates or precipitation of the particles or granules over time.
9) The term “shear thinning” refers to the non-Newtonian behavior of fluids whose viscosity decreases under shear strain. It may be considered synonymous for pseudoplastic behaviour and is usually defined as excluding time-dependent effects, such as thixotropy.
10) As used herein, the term “room temperature” refers herein to a temperature of from 15° C. to 35° C., preferably temperatures in the range 18° C. to 25° C. Such temperatures will include for example 18° C., 19° C., 20° C., 21° C., 22° C., 23° C., 24° C. and 25° C.
11) The word “average” refers to “number average” unless indicated otherwise.
12) As used herein, the singular forms “a”, “an”, and “the” include both singular and plural referents unless the context clearly dictates otherwise. By way of example, “an isocyanate group” means one isocyanate group or more than one isocyanate groups.
13) The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.
14) Throughout this application, the term “about” is used to indicate that a value includes the standard deviation or error for the device or method being employed to determine the value.
15) As used herein, the terms “% by weight”, “wt %”, “weight percentage”, or “percentage by weight” are used interchangeably.
16) The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

### DETAILED DESCRIPTION

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may be. Furthermore, the particular features, structures or characteristics may be combined in any suitable manner, as would be apparent to a person skilled in the art from this disclosure, in one or more embodiments.

Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

The present inventors have surprisingly found that one or more of the objects of the invention can be obtained by a 1 pot multistep process according to the invention.

In a first step, derivatized polysaccharide (also referred to as functionalized polysaccharide) is obtained by pre-reacting under well-defined reaction conditions at least one polysaccharide comprising at least one polysaccharide compound with a well-defined amount of an isocyanate-based liquid comprising at least one isocyanate-bearing compound in order to enable the polysaccharide compounds to be derivatized to obtain a derivatized polysaccharide and to improve the compatibility of the polysaccharide with isocyanate-based liquids. This first step is also referred to as the derivatization step.

The derivatized polysaccharide according to the invention is comprising pendant free isocyanate groups which makes the polysaccharide derivative compatible with isocyanate-based liquids and hence ideally suitable for making stable dispersions of derivatized polysaccharides in isocyanate-based liquids.

In a second step, the derivatized polysaccharide is diluted under stirring conditions with an isocyanate-based liquid comprising at least one isocyanate-bearing compound in order to make a dispersion of derivatized polysaccharide in an isocyanate-based liquid. This second step is also referred to as the dilution step.

In a third step, a composition comprising at least one isocyanate-reactive compound is added to the diluted polysaccharide derivative obtained in step 2 for predefined time at elevated temperatures using well-defined stirring conditions to achieve a stable dispersion of derivatized polysaccharide in an isocyanate prepolymer having preferably 5-20 wt %, more preferably 8-15 wt %, most preferably around 10 wt % derivatized polysaccharide calculated on the total weight of the dispersion and an NCO in the range 6% to 25%. This step is also referred to as the dispersing step. The obtained stable dispersion can be further diluted with isocyanate-based liquids if needed.

The stable dispersion of derivatized polysaccharide according to the invention can subsequently be used in different applications by further reaction/derivatization with other isocyanate-reactive functionalities, such as substrates, specialty chemicals, and polyurethane components.

The present invention therefore encompasses a process for making a stable dispersion of polysaccharide in isocyanate-based liquids comprising at least a first step for derivatizing the polysaccharide to obtain derivatized polysaccharide (derivatization step), a second step for further diluting the derivatized polysaccharide obtained in step 1 with an isocyanate-based liquid (dilution step) and a third step for making a stable dispersion of derivatized polysaccharides in an isocyanate-based liquid (dispersing step). The stable dispersion of derivatized polysaccharides is preferably a dispersion of derivatized polysaccharides in an isocyanate prepolymer made by adding isocyanate-reactive compounds to the derivatized polysaccharides in step 3.

One of the advantages of the present invention is the fact that the different processing steps for making a stable dispersion of polysaccharide in an isocyanate-based liquid can be performed in 1 reaction vessel (referred to as a “1 pot process”).

Therefore, the process according to the invention to make a stable dispersion of derivatized polysaccharide in an isocyanate-based liquid is comprising at least following steps:
1) Providing at least one polysaccharide comprising at least one polysaccharide compound and having a water content below 6 wt %, preferably below 4 wt %, more preferably below 2 wt % calculated on the total weight of the polysaccharide and an isocyanate-based liquid comprising at least one isocyanate-bearing compound and pre-reacting the at least one polysaccharide with the isocyanate-based liquid and then mixing the combined composition at room temperature Tr or at the melting temperature T. of the isocyanate-based liquid in case Tₘ>Tᵣ for at least 10 minutes such that the number of moles of the isocyanate-bearing compounds to the number of moles of OH groups originating from the polysaccharide compounds is in the range 0.3-0.7 to obtain a derivatized polysaccharide (derivatization step), and then
2) Diluting the derivatized polysaccharide obtained in the previous step with an isocyanate-based liquid comprising at least one isocyanate-bearing compound such that the amount of derivatized polysaccharide in the isocyanate-based liquid is in the range 10 up to 33 wt % calculated on the total weight of the derivatized polysaccharide+isocyanate-based liquid (dilution step), and then
3) Adding an isocyanate-reactive composition comprising at least one isocyanate-reactive compound to the composition obtained after the dilution step at elevated temperatures above the melting temperature T. of the isocyanate-based liquid and below 120° C. to obtain a stable dispersion of derivatized polysaccharide in an isocyanate-based liquid having an NCO value in the range 6-25%, preferably 8-21%, more preferably 10-16% (dispersion step).

In preferred embodiments, the derivatization step, the dilution step and the dispersion step are performed in the same reaction vessel.

In preferred embodiments, the isocyanate-based liquid used in the derivatization step and the dilution step are the same or different.

According to embodiments, the dilution step and the derivatization step are both performed at room temperature Tr or at the melting temperature Tₘ of the isocyanate-based liquid in case Tₘ>Tᵣ.

In some embodiments of the invention, the process according to the invention comprises one or more additional steps, such as further diluting with isocyanate-based liquid and/or adding additives such as but not limited to fillers, rheological modifiers, biocides, coloring agents, catalysts, plasticizers, adhesion promotors, anti-foaming agents, stabilizing agents . . . .

### Derivatization Step

According to preferred embodiments, after the derivatization step, derivatized polysaccharide is obtained. Said derivatized polysaccharide is a reaction product of at least one polysaccharide compound with at least one isocyanate-bearing compound wherein the number of moles of the isocyanate-bearing compounds to the number of moles of OH groups originating from the polysaccharide compounds is in the range 0.3 up to 0.7, preferably in the range 0.3 up to 0.6.

According to preferred embodiments, the at least one isocyanate-bearing compound used in the derivatization step is a difunctional isocyanate compound such as MDI and during the derivatization step one NCO equivalent is reacting with 1 OH equivalent being present in polysaccharide compound of the polysaccharide. Due to the limited number of available hydroxyl groups for reaction with the isocyanate-bearing compounds, the second NCO equivalent of the difunctional isocyanate compound is likely still available (free) for further reaction.

According to embodiments, the isocyanate-based liquid used in the derivatization step may be an isocyanate prepolymer having an NCO value higher than 5%, preferably in the range 10% up to 30%, more preferably in the range 15% up to 25%.

According to embodiments, the mixing of the at least one polysaccharide with the isocyanate-based liquid is performed for at least 10 minutes, preferably for 10-70 minutes, more preferably for 20-50 minutes, most preferably for 30-40 min.

According to embodiments, the water content of the polysaccharide used in the derivatization step according to the invention needs to be below 6 wt %, preferably below 4 wt %, more preferably lower than 2%. A pretreatment of the polysaccharide might be needed in order to remove excess of water. This pretreatment might involve placing the polysaccharide for a predefined time (e.g. 2-3 hours) in an oven at a temperature in the range 70° C. up to 130° C. to reduce moisture content down to 2 wt % or lower (calculated on the total weight of the polysaccharide). Temperatures of around 80° C. for 3 hours or alternatively around 120° C. for 1 hour might be used to remove the excess of water content. Preferably, the removal of the excess of water in the polysaccharide should be such that the crystallinity of the polysaccharide remains almost unchanged.

In a preferred embodiment, the at least one polysaccharide in the derivatization step is present in an amount ranging from 13 to 57% by weight, based on the total weight of the at least one polysaccharide and the isocyanate-based liquid combined. Preferably, the at least one polysaccharide in step (a) is present in an amount ranging from 18 to 42% by weight, even more preferably ranging from 20 to 35%, most preferably ranging from 25 to 30% by weight, based on the total weight of the at least one polysaccharide and the isocyanate-based liquid combined.

The derivatization step of the process according to the invention is preferably performed at least at a temperature above the melting temperature T. of the isocyanate-based liquid and below 70° C., preferably at a temperature below 60° C., more preferably at a temperature below 50° C., most preferably at a temperature below 43° C. In case room temperature Tr is above the melting temperature T. of the isocyanate-based liquid, the derivatization step is performed at room temperature Tr. In case the melting temperature T. of the isocyanate-based liquid is above the Tr, the derivatization step is performed at the melting temperature T. of the isocyanate-based liquid.

In a preferred embodiment, the derivatization step of the process according to the invention is performed for a time period of at least 30 minutes before the dilution step can take place. Preferably, the derivatization step comprises mixing the at least one polysaccharide with the isocyanate-based liquid for at least 10 minutes, more preferably between 10-70 minutes, more preferably between 20-50 minutes, most preferably between 30-40 minutes. The aforementioned times are preferred times for temperatures of at most 50° C. For higher temperatures, the derivatization step may be shorter.

According to embodiments, the polysaccharide derivative, obtained by the process of the present invention, comprises a polysaccharide backbone and one or more pendant groups attached to the polysaccharide backbone via a carbamate —O—C(═O)—NH— link. Such a carbamate link may be formed by the reaction of a free isocyanate —N═C═O group with a hydroxyl group of a polysaccharide backbone.

According to embodiments, the polysaccharide derivative, obtained by the process of the present invention, comprises a polysaccharide backbone and one or more pendant groups attached to the polysaccharide backbone via a urea —NH—C(═O)—NH— link. Such a urea link may be formed by the reaction of a free isocyanate —N═C═O group with an amine group of a polysaccharide backbone.

According to embodiments, the polysaccharide derivative, obtained by the process of the present invention, comprises a polysaccharide backbone and one or more pendant groups attached to the polysaccharide backbone via an allophanate —NH—C(═O)—N(—C(═O)—O—)— link. Such an allophanate link may be formed by the reaction of a free isocyanate —N=C=O group with a urethane group of a polysaccharide backbone.

According to embodiments, the polysaccharide derivative, obtained by the process of the present invention, comprises a polysaccharide backbone and one or more pendant groups attached to the polysaccharide backbone via a biuret —NH—C(═O)—N(—C(═O)—NH—)— link. Such a biuret link may be formed by the reaction of a free isocyanate —N═C═O group with a urea group of a polysaccharide backbone.

According to embodiments, the polysaccharide derivative, obtained by the process of the present invention, comprises polysaccharide compounds having on their backbone pendant groups attached to the polysaccharide backbone via a carbamate, urea, allophanate and/or biuret link.

Preferably the one or more pendant groups attached to the polysaccharide backbone comprise at least one free isocyanate —N═C═O group, which may be used for further functionalization.

### Dilution Step

In a preferred embodiment, the derivatized polysaccharide obtained in the derivatization step according to the invention is further diluted with an isocyanate-based liquid. The dilution step is preferably performed by mixing the derivatized polysaccharide with an isocyanate-based liquid, preferably by stirring or shaking at low speed velocities, preferably mixing with a dynamic or static stirrer using velocities in the range 200 up to 500 rpm, for example using velocities around 250 rpm. Preferably the mixing is performed using velocities below 3000 rpm, more preferably below 2000 rpm, more preferably below 1000 rpm.

According to embodiments, the isocyanate-based liquid used for the derivatization step and the dilution step are the same or different.

According to embodiments, the derivatized polysaccharide obtained in the derivatization step is diluted with an isocyanate based liquid comprising at least one isocyanate-bearing compound such that the amount of derivatized polysaccharide in the isocyanate-based liquid is in the range 10 up to 33 wt %, preferably in the range 14 up to 20 wt % calculated on the total weight of the derivatized polysaccharide+isocyanate-based liquid.

According to embodiments, the derivatized polysaccharide obtained in the derivatization step is diluted with an isocyanate-based liquid comprising at least one isocyanate-bearing compound such that the NCO value of the diluted composition is in the range 14 up to 50%, preferably in the range 22 up to 30%, more preferably in the range 23 up to 28%.

### Dispersion Step

According to embodiments, the dispersion step is performed by mixing the obtained composition of the dilution step with at least one isocyanate-reactive compound and optionally at least one catalyst. Any other step can also be performed in the presence of a catalyst.

According to preferred embodiments, the isocyanate-reactive compounds used in the dispersion step are selected from isocyanate-reactive compounds having isocyanate reactive hydrogen atoms such as amines and polyols. Typically, the isocyanate-reactive compounds are selected from hydroxyl terminated polyethers (polyether polyols), hydroxyl terminated polycarbonates and hydroxyl terminated polyesters (polyester polyol) or mixture thereof.

According to embodiments, the dispersion step is performed at elevated temperatures which are at least above the melting temperature T. of the isocyanate-based liquid used in the dilution step and below 120° C. Preferably the temperature is above T. of the isocyanate-based liquid and below 120° C., more preferably in the range 50° C. up to 100° C., most preferably in the range 50° C. up to 85° C. (depending on the type of isocyanate-bearing compounds used). Temperatures in the range 70° C. up to 85° C., preferably around 80 ° C. are preferred when the isocyanate-based liquid is MDI.

According to embodiments, before adding the isocyanate-reactive compounds to the reaction vessel, the reaction vessel is heated up to a temperature suitable for pre-polymerization of the isocyanate-bearing compounds in the isocyanate-based liquid with the added isocyanate-reactive compounds. This might involve heating the diluted polysaccharide derivative up to 50° C.-60° C. and then slowly feeding the isocyanate-reactive compounds into the reaction vessel and controlling the addition rate so that the temperature does not exceed 120° C. and cooling the reaction vessel if necessary.

According to embodiments, the dispersion step is performed by adding an isocyanate-reactive composition comprising at least one isocyanate-reactive compound to the composition obtained after the dilution step to obtain a stable dispersion of derivatized polysaccharide in an isocyanate-based liquid having an NCO value in the range 6-25%, preferably 8-21%, more preferably 10-16%. The isocyanate-based liquid of the obtained stable dispersion can also be referred to as an isocyanate prepolymer having unreacted free NCO groups.

According to embodiments, the dispersion step is performed by adding an isocyanate-reactive composition comprising at least one isocyanate-reactive compound to the composition obtained after the dilution step at elevated temperatures for a predefined time and mixing for at least 60 minutes, preferably for at least 90 minutes, more preferably for at least 120 minutes.

According to embodiments, the catalyst used in the dispersion step may be selected from an organometallic catalyst.

According to embodiments, the catalyst may be present in an amount of at least 10 ppm, for example at least 0.01% by weight, for example at least 0.20% by weight, with % by weight based on the total weight of the diluted polysaccharide derivative (the mixture obtained after the dilution step).

In some embodiments the catalyst may be present in an amount of at most 5% by weight, based on the total weight of the mixture obtained after the dilution step.

According to embodiments, the stable dispersion comprising the derivatized polysaccharide according to the invention is an isocyanate prepolymer comprising dispersed derivatized polysaccharide having shear thinning behaviour.

According to preferred embodiments, the stable dispersion comprising the derivatized polysaccharide according to the invention is an isocyanate prepolymer comprising preferably 5-20 wt %, more preferably 8-15 wt %, most preferably around 10 wt % dispersed derivatized polysaccharide calculated on the total weight of the stable dispersion. This dispersion can be further diluted with an isocyanate-based liquid if needed to achieve lower wt % of derivatized polysaccharide.

The stable dispersion of derivatized polysaccharide according to the invention is ideally suitable for making composites, adhesives, coatings, fillers, fibers, packaging, films, foams, textiles, sealants, rheology modifiers, paints, chromatography packing (solid phase) etc.

The stable dispersion comprising the derivatized polysaccharide according to the invention (an isocyanate prepolymer comprising dispersed polysaccharide derivatives) are dispersions which show improved strength when glued to metal, plastic and wood. When applied to glue wood and/or plastic substrates to each other, these dispersions give rise to 80-100% substrate failure.

The stable dispersion comprising the derivatized polysaccharide according to the invention (an isocyanate prepolymer comprising dispersed polysaccharide derivatives) are dispersions which show improved strength when glued to metal, plastic and wood. When applied to glue wood and/or plastic substrates to each other, these dispersions give rise to a faster cure.

### Polysaccharides Suitable for Use According to the Invention

As used herein, the term “polysaccharide” refers to compounds comprising at least 5 monomer saccharide sub-units joined together by glycosidic bonds.

Preferably, the at least one polysaccharide has a degree of polymerization of at least 10, more preferably of at least 20, more preferably of at least 50, for example of at least 100, for example of at least 150, for example of at least 200, for example of at least 500.

The at least one polysaccharide may be natural or synthetic. The at least one polysaccharide may be crude or purified. The at least one polysaccharide may be original or (partially) pre-derivatized or modified. The at least one polysaccharide may be linear, branched or cyclic. The at least one polysaccharide may be a homopolysaccharide (also referred to as homoglycan) or a heteropolysaccharide (also referred to as heteroglycan).

Preferably, the at least one polysaccharide is hexose based, i.e. the at least one polysaccharide comprises at least one hexose sub-unit. Preferably the at least one polysaccharide comprises at least 50% by weight of hexose sub-units, based on the total weight of the polysaccharide, more preferably at least 75% by weight, more preferably at least 90% by weight. Preferably the at least one polysaccharide is cyclic hexose based.

In a preferred embodiment, the at least one polysaccharide comprises at least one glucose sub-unit. Preferably the at least one polysaccharide comprises at least 50% by weight of glucose sub-units, based on the total weight of the polysaccharide, more preferably at least 75% by weight, more preferably at least 90% by weight. The glucose sub-units may be modified glucose sub-units, for example amino-glucose sub-units, with a substituent on the C2 or C3 position.

In some embodiments, the at least one polysaccharide is selected from the group comprising: cellulosic compounds; starches (such as amylose or amylopectin or mixtures thereof);

agarose; alginic acid; alguronic acid; alpha glucan; amylopectin; amylose; arabinoxylan; beta-glucan; callose; capsulan; carrageenan; cellodextrin; cellulin; chitin; chitosan; chrysolaminarin; curdlan; cyclodextrin; DEAE-sepharose; dextran; dextrin; alpha-cyclodextrin; ficoll; fructan; fucoidan; galactoglucomannan; galactomannan; gellan gum; glucan; glucomannan; glycocalyx; glycogen; hemicellulose; hypromellose; icodextrin; kefiran; laminarin; lentinan; levan; lichenin; maltodextrin; mixed-linkage glucan; mucilage; natural gum; oxidized cellulose; paramylon; pectic acid; pectin; pentastarch; pleuran; polydextrose; polysaccharide peptide; porphyran; pullulan; schizophyllan; sepharose; sinistrin; sizofiran; sugammadex; welan gum; xanthan gum; xylan; xyloglucan; zymosan; glycosaminoglycans such as glycosaminoglycan, chondroitin, chondroitin sulfate, dermatan sulfate, heparan sulfate, heparin, heparinoid, hyaluronan, keratan sulfate, restylane, sodium hyaluronate, and sulodexide; and mixtures thereof. In preferred embodiments, the at least one polysaccharide is selected from the group comprising cellulosic compounds and starches.

In an embodiment, the at least one polysaccharide is a starch selected from the group comprising: corn starch, amylose, acetylated distarch adipate, amylomaize, amylopectin, cyclodextrin, dextrin, dialdehyde starch, erythronium japonicum, high-fructose corn syrup, hydrogenated starch hydrosylate, hydroxyethyl starch, hydroxypropyl distarch phosphate, maltitol, maltodextrin, maltose, pentastarch, phosphated distarch phosphate, potato starch, starch, waxy corn, waxy potato starch, and mixtures thereof.

In an embodiment, the at least one polysaccharide is a cellulosic compound selected from the group comprising: cellulose, nanocellulose, art silk, bacterial cellulose, bamboo fibre, carboxymethyl cellulose, cellodextrin, cellophane, celluloid, cellulose acetate, cellulose acetate phthalate, cellulose triacetate, cellulosome, cotton, croscarmellose sodium, crystalate, ciethylaminoethyl cellulose, dissolving pulp, ethulose, ethyl cellulose, fique, hydroxyethyl cellulose, hydroxyethyl methyl cellulose, hydroxypropyl cellulose, hypromellose, lyocell, mercerised pulp, methyl cellulose, microbial cellulose, microcrystalline cellulose, modal (textile), nitrocellulose, parkesine, pearloid, pulp, paper, rayon, sodium cellulose phosphate, supima, viscose, vulcanized fibre, wood fibre, and mixtures thereof.

In a preferred embodiment, the polysaccharide is cellulose. As used herein, the term “cellulose” refers to a polysaccharide comprising a linear chain of several hundred to over ten thousand β(1→4) linked D-glucose units.

Isocyanate Bearing Compounds Suitable for Use According to the Invention

As used herein, the term isocyanate-bearing compound comprises any compound comprising at least one isocyanate —N═C═O group, whereby the isocyanate group may be a terminating group. Preferably, the isocyanate group is a terminating group. Isocyanate-bearing compounds are preferably polyisocyanate compounds. Suitable polyisocyanates used may be araliphatic and/or aromatic polyisocyanates, typically of the type R'(NCO)ₓ with x being at least 1, preferably at least 2, and R being an aromatic or combined aromatic/aliphatic group. Examples of R are diphenylmethane, toluene, or groups providing a similar polyisocyanate.

In a preferred embodiment, the isocyanate-bearing compound is a polyisocyanate. Due to partial surface crosslinking (intra and interstrand crosslinking between cellulosic chains) by the polyisocyanate, the bulk of the cellulosic substrate may be protected against further derivatization. In this way, the crystalline, stiff nature of the cellulosic backbone may be preserved for further applications, in which the bulk properties of the cellulosic are required (e.g. for composites). Free isocyanate groups may also be used for further functionalization or derivatization. The free isocyanate groups of polyisocyanates may also trimerize to form isocyanurates groups.

In a preferred embodiment, the at least one isocyanate-bearing compound is a polyisocyanate selected from the group comprising: methylene diphenyl diisocyanate in the form of its 2,4′-, 2,2′- and 4,4′-isomers and mixtures thereof, the mixtures of methylene diphenyl diisocyanates and oligomers thereof, or their derivatives having a urethane, isocyanurate, allophonate, biuret, uretonimine, uretdione and/or imino-oxadiazinedione groups and mixtures thereof; toluene diisocyanates and isomer mixtures thereof; tetramethylxylene diisocyanate; 1,5-naphtalenediisocyanate; p-phenylenediisocyanate; tolidine diisocyanate; or mixtures of these organic polyisocyanates, and mixtures of one or more of these organic polyisocyanates with methylene diphenyl diisocyanate in the form of 2,4′-, 2,2′- and 4,4′-isomers and mixtures thereof, the mixtures of methylene diphenyl diisocyanate and oligomers thereof.

In an embodiment, the at least one isocyanate-bearing compound is the reaction product of polyisocyanates (e.g. polyisocyanates as set out above), with components containing isocyanate-reactive hydrogen atoms forming polymeric polyisocyanates or so-called prepolymers. The prepolymer can be generally prepared by reacting a polyisocyanate with isocyanate reactive components which are typically components containing isocyanate-reactive hydrogen atoms, such as a hydroxyl terminated polyether (polyether polyols), a hydroxyl terminated polycarbonate or mixture thereof, and hydroxyl terminated polyesters (polyester polyol).

In a preferred embodiment, the isocyanate-bearing compound comprises MDI. Preferably, the MDI is in the form of its 2,4′-, 2,2′- and 4,4′-isomers and mixtures thereof, or in the form of the mixtures of diphenylmethane diisocyanates (MDI) and oligomers thereof. In some embodiments, the MDI is in the form of its 2,4′ and 4,4′-isomers and mixtures thereof, or in the form of the mixtures of these diphenylmethane diisocyanates (MDI) and oligomers thereof. In some embodiments, the MDI is in the form of its 2,4′ isomer, or in the form of the mixtures of the 2,4′isomer and oligomers thereof. The use of 2,4′-MDI containing isocyanates partially inhibits crosslinking between two cellulosic chains compared to the use of pure 4,4′-MDI, which results in more crosslinking. So by the choice of the initial MDI type, the amount of pendant isocyanates and extent of crosslinking can be tailored. Preferably, the at least one isocyanate is a mixture of 2,4′- or 4,4′-MDI. In some embodiments, the polyisocyanate comprises a polymeric polyisocyanate. In some embodiments, the polyisocyanate comprises a high functionality polymeric polyisocyanate, with a functionality of at least 2.5, preferably at least 2.7. As used herein, the term “functionality” refers to the average number of isocyanate groups per molecule, averaged over a statistically relevant number of molecules present in the isocyanate.

In some embodiments, the at least one isocyanate-bearing compound comprises a polymeric methylene diphenyl diisocyanate (MDI).

The polymeric methylene diphenyl diisocyanate can be any mixture of pure MDI (2,4′-, 2,2′- and 4,4′-methylene diphenyl diisocyanate) and higher homologues thereof.

Isocyanate-Reactive Compounds Suitable for Use According to the Invention

The isocyanate-reactive compounds suitable for forming isocyanate prepolymers and/or stable dispersions of derivatized polysaccharide according to the invention are compounds containing isocyanate-reactive hydrogen atoms such as amines and polyols. Typically, the isocyanate-reactive compounds are hydroxyl terminated polyethers (polyether polyols), hydroxyl terminated polycarbonates, hydroxyl terminated polyesters (polyester polyol) or mixture thereof. Non-limiting examples of suitable polyether polyols are preferably polyether polyols derived from a diol or polyol having a total of from 2 to 15 carbon atoms, preferably an alkyl diol or glycol which is reacted with an ether comprising an alkylene oxide having from 2 to 6 carbon atoms, typically ethylene oxide or propylene oxide or mixtures thereof, preferably having a functionality of at least 2, for example from 2 to 6. Hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, poly(propylene glycol) comprising propylene oxide reacted with propylene glycol, poly(tetramethyl glycol) (PTMG) comprising water reacted with tetrahydrofuran (THF). Polyether polyols can further include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the current invention. Typical copolyethers include the reaction product of glycerol and ethylene oxide or glycerol and propylene oxide. The various polyether intermediates generally have a number average molecular weight (Mn), as determined by assay of the terminal functional groups which is an average molecular weight, of from about 200 to about 10000, desirably from about 200 to about 5000, and preferably from about 200 to about 3000.

According to embodiments, the isocyanate reactive compounds are polyether polyols, such as EO-tipped polyether polyols. Suitable EO-tipped polyether polyol comprises polyether polyol having a structure I—[R—(CH₂CH₂O)ₚH]ₓ, wherein x is an integer equal or more than 1, p is a number varying from 1 to 100, I is an initiator and R represents a series of epoxides, the (CH₂CH₂O)ₚH groups being bound to R via an ether bond. The initiator I may be an alcohol, an amine, a polyalcohol, a polyamine or a component comprising one or more alcohol groups and one of more amine groups.

Catalysts Suitable for Use in a Process According to the Invention

According to embodiments, a catalyst may be added in the dispersion step to catalyze the pre-polymerization of the isocyanate-bearing compounds with the isocyanate-reactive compounds in order to form isocyanate prepolymers. Any catalyst as known by those skilled in the art for making polyurethane materials may be used.

According to embodiments, the catalyst may be an organometallic catalyst. In these embodiments, the catalyst comprises an element selected from the group comprising tin, iron, lead, bismuth, mercury, titanium, hafnium, zirconium, and combinations thereof. In certain embodiments, the catalyst comprises a tin catalyst. Suitable tin catalysts, for purposes of the present invention, may be selected from tin(II) salts of organic carboxylic acids, e.g. tin(II) acetate, tin(II) octoate, tin(II) ethylhexanoate and tin(II) laurate. In an embodiment, the organometallic catalyst comprises dibutyltin dilaurate, which is a dialkyltin(IV) salt of an organic carboxylic acid. The organometallic catalyst can also comprise other dialkyltin(IV) salts of organic carboxylic acids, such as dibutyltin diacetate, dibutyltin maleate and dioctyltin diacetate. Specific examples of suitable organometallic catalyst, e.g. dibutyltin dilaurates, for purposes of the present invention, are commercially available from Air Products and Chemicals, Inc. under the trademark of DABCO®. Preferred catalysts according to the invention are dibutyl tin dilaurate, dibutyl tin diacetate, dioctyl tin diacetate, and tin octoate.

Non-limiting examples of other suitable catalysts, may be selected from the group comprising iron(II) chloride; zinc chloride; lead octoate; tri s(dialkylaminoalkyl)-s-hexahydrotriazines including tris(N,N-dimethylaminopropyl)-s-hexahydrotriazine;

tetraalkylammonium hydroxides including tetramethylammonium hydroxide; alkali metal hydroxides including sodium hydroxide and potassium hydroxide; alkali metal alkoxides including sodium methoxide and potassium isopropoxide; and alkali metal salts of long-chain fatty acids having from 10 to 20 carbon atoms and/or lateral OH groups; triethylamine, N,N,N′,N′-tetramethylethylenediamine, N,N-dimethylaminopropylamine, N,N,N′,N′,N″-pentamethyldipropylenetriamine, tris(dimethylaminopropyl)amine, N,N-dimethylpiperazine, tetramethylimino-bis(propylamine), dimethylbenzyl amine, trimethyl amine, triethanolamine, N,N-diethyl ethanolamine, N-methylpyrrolidone, N-methylmorpholine, N-ethylmorpholine, bis(2-dimethylamino-ethyl)ether, N,N-dimethylcyclohexylamine (DMCHA), N,N,N′,N′,N″-pentamethyldiethylenetriamine, 1,2-dimethylimidazole, 3 -(dimethyl amino) propylimidazole,; N,N,N-dimethylaminopropylhexahydrotriazine, potassium acetate, N,N,N-trimethyl isopropyl amine/formate, and combinations thereof. It is to be appreciated that the catalyst component may include any combination of two or more of the aforementioned catalysts.

The derivatized polysaccharide according to the invention and stable dispersions comprising the derivatized polysaccharide obtained by the process of the present invention may be used in packaging, films, foams, composites, adhesives, coatings, textiles, sealants, rheology modifiers, paints, chromatography packing (solid phase) etc.

In a preferred embodiment, the derivatized polysaccharide according to the invention as such or being present in the stable dispersion according to the invention is in the form of granules, wherein the granules have a particle size distribution wherein the D50 is at most 1.0 mm, preferably at most 200 micron (μm), more preferably at most 100 micron (μm) and in the most preferred embodiment at most 30 micron (μall), wherein D50 is defined as the particle size for which fifty percent by weight of the particles has a size lower than 30 micron (μm). For example, the D50 (and/or D90 or D95) can be measured by sieving, by BET surface measurement, or by laser diffraction analysis, for example according to standard ISO 13320:2009.

In a preferred embodiment, the derivatized polysaccharide according to the invention as such or being present in the stable dispersion according to the invention is in the form of a yarn or fiber, with a linear mass density of at most 2000 denier, preferably between 5 and 2000 denier, preferably between 5 and 500 denier, and in the most preferred embodiment between 5 and 200 denier.

In a preferred embodiment, the derivatized polysaccharide according to the invention as such or being present in the stable dispersion according to the invention is in the form of a textile or fabric, wherein the textile or fabric may be woven or unwoven.

The crystallinity index (CI) of the at least one polysaccharide may be at least 10%, for example at least 20%, for example at least 30%, for example at least 40%, for example at least 50%, for example at least 60%, for example at least 70%.

### EXAMPLES

The examples described hereunder illustrate the properties of the processes and polysaccharide derivatives according to embodiments of the present invention. Unless otherwise indicated, all parts and all percentages in the following examples, as well as throughout the specification, are parts by weight or percentages by weight respectively.

Chemicals
SUPRASEC® 2020 (S2020) is a uretonimine modified grade of MDI with an NCO value of 29.5% and functionality (f) of 2.11. S2020 is supplied by Huntsman and used as received.
SUPRASEC® 2144 (S2144) is an MDI prepolymer with NCO value of 15.2%.
SUPRASEC® 3050 (S3050) is a mixture of 4,4′-MDI and 2,4′-MDI with an NCO value of 33.6% and functionality (f) of 2. S3050 is supplied by Huntsman and used as received.
ARBOCELL® BE 600/30 is a highly pure white a-cellulose fiber with an average fiber length of 30 μm supplied by J. Rettenmair & Sohne (JRS). The cellulose is dried prior to use.
Avicel is a microcrystalline cellulose with average fiber length of 50 μm. The cellulose is dried prior to use.
DALTOCEL® F456 (F456) is a polyether polyol with a with a hydroxyl value of 56 mgKOH/g of sample and f of 2. F456 was supplied by Huntsman and used after drying.
HPLC grade Acetonitrile (AN) supplied by Rathburn and used as received.
Anhydrous grade DMSO (Dimethyl Sulfoxide) supplied by Sigma-Aldrich and used as received.

Methods

The following methods were used in the examples:
FT-IR analysis (in ATR mode) was used to identify urethane stretch modes and isocyanate stretch modes.

### Example 1

### According to the Invention: MDI-Derivatized Cellulose Containing Prepolymer

Alpha cellulose (ARBOCEL® BE600-30) was dried under vacuum at 80° C. for 3 hours to reduce the moisture content in the cellulose from 6.6 wt % down to 2 wt % (calculated on the total weight of the cellulose). 100 gram of the dry cellulose was weighed into a reaction flask and subsequently 280 gram of SUPRASEC® 2020 (S2020) was added to the reaction flask under N₂. The slurry was stirred at 150 rpm for 40 minutes at room temperature (20° C.) to obtain derivatized cellulose. The mixture obtained here is a dispersion of 26 wt % of derivatized cellulose solids in S2020.

After 40 minutes, an additional amount of 233 gram S2020 was added to the derivatized cellulose (16 wt % of solid in the dispersion). This yields a mixture of approximately 16 wt % of derivatized cellulose solids in S2020.

The mixture was then heated to 78° C.±1.5° C. and mixed continuously while dried DALTOCEL® F456 was then added dropwise via addition funnel. The reaction was then left to mix until an isocyanate prepolymer with NCO value around 12% was achieved (measured by titration according to DIN 53185). A stable dispersion containing 10 wt % derivatized cellulose as a solid in the dispersion was obtained displaying no noticeable sedimentation after 24 hours.

FT-IR analysis (in ATR mode) on the cellulose filtered off from the mixture, washed with acetonitrile and dried showed urethane (1730 cm⁻¹) and isocyanate peak (2240 cm⁻¹).

### Comparative Example 1

Microcrystalline cellulose (Avicel®) was dried under vacuum at 60° C. for 12 hours to reduce the moisture content in the cellulose from 6.6 wt % down to 2 wt % (calculated on the total weight of the cellulose). 40 gram of the dry cellulose was weighed into a reaction flask and subsequently 160 gram of anhydrous dimethylsulfoxide (solvent) was added and the mixture (20w% cellulose in solvent) was stirred at room temperature for 1 hour. 56 gram isocyanate S3050 (a mixture of 50% 4,4′-MDI and 2,4′-MDI) was added to the reaction flask while blanketing with nitrogen and stirring vigorously (0.3 mole of MDI per mole of OH) for 30 min. The cellulose was then filtered off and washed with dry acetonitrile. The material was then dried under vacuum. The FTIR analysis showed urethane (1730 cm⁻¹) and isocyanate peak (2240 cm⁻¹).

The derivatized cellulose prepared above was dispersed in SUPRASEC® 2144 (MDI prepolymer by high shear mixing at 3000 rpm for 4 hours. A stable dispersion containing 10 wt % derivatized cellulose as a solid in the dispersion was obtained displaying no noticeable sedimentation after 24 hours.

### Comparative Example 2

Alpha cellulose (ARBOCEL® BE600-30) was dried under vacuum at 80° C. for 3 hours to reduce the moisture content in the cellulose from 6.6 wt % down to 2 wt % (calculated on the total weight of the cellulose). 100 gram of the dry cellulose was weighed into a reaction flask and subsequently 513 gram of SUPRASEC® 2020 (S2020) was added to the reaction flask under N₂. This yields a mixture of approximately 16 wt % of cellulose solids in S2020.

The mixture was then heated to 78° C.±1.5° C. and mixed continuously while dried DALTOCEL® F456 was then added dropwise via addition funnel. The reaction was then left to mix until an isocyanate prepolymer with NCO value around 12% was achieved (measured by titration according to DIN 53185). A mixture containing 10 wt % cellulose as a solid in the mixture was obtained which was not stable and showed sedimentation after 24 hours.

FT-IR analysis (in ATR mode) on the cellulose filtered off from the mixture, washed with acetonitrile and dried showed no urethane (1730 cm⁻¹) and no isocyanate peak (2240 cm⁻¹).

### Comparative Example 3

Alpha cellulose (ARBOCEL® BE600-30) was dried under vacuum at 80° C. for 3 hours to reduce the moisture content in the cellulose from 6.6 wt % down to 2 wt % (calculated on the total weight of the cellulose). 100 gram of the dry cellulose was weighed into a reaction flask and subsequently 443 gram of SUPRASEC® 2020 (S2020) was added to the reaction flask under N₂. The slurry was stirred at 150 rpm for 40 minutes at room temperature (20° C.). The mixture obtained here is a mixture of 18.4 wt % of cellulose solids in S2020.

After 40 minutes, an additional amount of 70 gram S2020 was added to the derivatized cellulose. This yields a mixture of approximately 16 wt % of cellulose solids in S2020.

The mixture was then heated to 78° C.±1.5° C. and mixed continuously while dried DALTOCEL® F456 was then added dropwise via addition funnel. The reaction was then left to mix until an isocyanate prepolymer with NCO value around 12% was achieved (measured by titration according to DIN 53185). A mixture containing 10 wt % cellulose as a solid in the mixture was obtained which was not stable and showed sedimentation after 24 hours.

FT-IR analysis (in ATR mode) on the cellulose filtered off from the mixture, washed with acetonitrile and dried showed no urethane (1730 cm⁻³) and no isocyanate peak (2240 cm⁻³).

Examples on Applications

Following examples demonstrate that the stable dispersions with derivatized polysaccharide prepared according to the invention are ideally suitable for use as adhesive when applied to lap joints.

Below examples compare the stable dispersions with derivatized polysaccharide prepared according to the invention with comparable isocyanate prepolymers without derivatized polysaccharide.

Preparing Lap-Joints

The stable dispersion obtained in example 1 was applied on the conditioned surface of a beech substrate with a loading of 0.032g/cm² (0.2g of resin) applied by brush to create a 0.1mm thick glue line then paired with a substrate lacking any adhesive to obtain lap-joints according to the invention. Comparative lap-joints were prepared by applying the prepolymer from example 1 without dispersed polysaccharide (referred to as prepolymer S2144). Each substrate series consisted of 6 lap joints.

The lap joints were then tested for mechanical properties (shear strength test). The maximum load at break of beech lap-joints were compared for each prepolymer. From this data we can conclude that the lap shear strength for the lap -j oints according to the invention is 100% higher compared to the comparative lap-joints.

The results showed that adhesives made from the stable dispersion having derivatized polysaccharide according to the invention were stronger than the wood, resulting in substrate failure.

In summary these results show significant increase in mechanical properties in comparison to non-cellulose containing prepolymers.

1. A process for making a stable dispersion of derivatized polysaccharide in an isocyanate-based liquid comprising at least the following steps:
1) Providing at least one polysaccharide comprising at least one polysaccharide compound and having a water content below 6 wt % calculated on the total weight of the polysaccharide and an isocyanate-based liquid comprising at least one isocyanate-bearing compound and pre-reacting the at least one polysaccharide with the isocyanate-based liquid and then mixing the combined composition for at least 10 minutes at either room temperature “Tᵣ” or at the melting temperature “Tₘ” of the isocyanate-based liquid if Tₘ>Tᵣ such that the number of moles of the isocyanate-bearing compounds to the number of moles of OH groups originating from the polysaccharide compounds is in a range 0.3 up to 0.7 to obtain a derivatized polysaccharide (“derivatization step”), and then
2) Diluting the derivatized polysaccharide with an isocyanate-based liquid comprising at least one isocyanate-bearing compound such that the amount of derivatized polysaccharide in the isocyanate-based liquid is in a range 10 wt % up to 33 wt % calculated on the total weight of the derivatized polysaccharide and the isocyanate-based liquid (“dilution step”),
3) Adding an isocyanate-reactive composition comprising at least one isocyanate-reactive compound to the composition obtained after the dilution step at elevated temperatures above Tₘ and below 120° C. and mixing for at least 60 minutes to obtain a stable dispersion of 5 to 20 wt % of derivatized polysaccharide in an isocyanate-based liquid based on the total weight of the stable dispersion and said stable dispersion having an NCO value in the range 6-25% (“dispersion step”).

2. Process according to claim 1 wherein the derivatization step, the dilution step and the dispersion step are performed in the same reaction vessel.

3. Process according to claim 1 wherein the isocyanate-based liquid used in the derivatization step and the dilution step are the same or different.

4. Process according to claim 1 wherein the dilution step and the derivatization step are both performed at room temperature Tᵣ or at the melting temperature Tₘ of the isocyanate-based liquid if Tₘ>Tᵣ.

5. Process according to claim 1 wherein the at least one polysaccharide in the derivatization step is present in an amount ranging from 13 to 57% by weight, based on the total weight of the at least one polysaccharide and the at least one compound combined.

6. Process according to claim 1 wherein the derivatization step is performed at least at a temperature above the melting temperature Tₘ of the isocyanate-based liquid and below 70° C.

7. Process according to claim 1 wherein the derivatization step is performed for at least 10 minutes.

8. Process according to claim 1 wherein the derivatized polysaccharide obtained in the derivatization step is diluted with an isocyanate based liquid comprising at least one isocyanate-bearing compound such that the amount of derivatized polysaccharide in the isocyanate-based liquid is in the range 10 up to 33 wt % calculated on the total weight of the derivatized polysaccharide+isocyanate-based liquid.

9. Process according to claim 1 wherein the derivatized polysaccharide obtained in the derivatization step is diluted with an isocyanate based liquid comprising at least one isocyanate-bearing compound such that the NCO value of the diluted composition is in the range 14 up to 50%.

10. Process according to claim 1 wherein the at least one polysaccharide is selected from the group comprising: cellulosic compounds; starches; agarose; alginic acid; alguronic acid; alpha glucan; amylose, amylopectin; arabinoxylan; beta-glucan; callose; capsulan; carrageenan; cellodextrin; cellulin; chitin; chitosan; chrysolaminarin; curdlan; cyclodextrin; DEAE-sepharose; dextran; dextrin; alpha-cyclodextrin; ficoll; fructan; fucoidan; galactoglucomannan; galactomannan; gellan gum; glucan; glucomannan; glycocalyx; glycogen; hemicellulose; hypromellose; icodextrin; kefiran; laminarin; lentinan; levan; lichenin; maltodextrin; mixed-linkage glucan; mucilage; natural gum; oxidized cellulose; paramylon; pectic acid; pectin; pentastarch; pleuran; polydextrose; polysaccharide peptide; porphyran; pullulan; schizophyllan; sepharose; sinistrin; sizofiran; sugammadex; welan gum; xanthan gum; xylan; xyloglucan; zymosan; glycosaminoglycans such as glycosaminoglycan, chondroitin, chondroitin sulfate, dermatan sulfate, heparan sulfate, heparin, heparinoid, hyaluronan, keratan sulfate, restylane, sodium hyaluronate, and sulodexide; and mixtures thereof.

11. Process according to claim 1 wherein the at least one polysaccharide is a cellulosic compound selected from the group comprising: cellulose, nanocellulose, art silk, bacterial cellulose, bamboo fibre, carboxymethyl cellulose, cellodextrin, cellophane, celluloid, cellulose acetate, cellulose acetate phthalate, cellulose triacetate, cellulosome, cotton, croscarmellose sodium, crystalate, ciethylaminoethyl cellulose, dissolving pulp, ethulose, ethyl cellulose, fique, hydroxyethyl cellulose, hydroxyethyl methyl cellulose, hydroxypropyl cellulose, hypromellose, lyocell, mercerised pulp, methyl cellulose, microbial cellulose, microcrystalline cellulose, modal (textile), nitrocellulose, parkesine, pearloid, pulp, paper, rayon, sodium cellulose phosphate, supima, viscose, vulcanized fibre, wood fibre, and mixtures thereof.

12. Process according to claim 1 wherein the at least one polysaccharide is a starch selected from the group comprising: corn starch, amylose, acetylated distarch adipate, amylomaize, amylopectin, cyclodextrin, dextrin, dialdehyde starch, erythronium japonicum, high-fructose corn syrup, hydrogenated starch hydrosylate, hydroxyethyl starch, hydroxypropyl distarch phosphate, maltitol, maltodextrin, maltose, pentastarch, phosphated di starch phosphate, potato starch, starch, waxy corn, waxy potato starch, and mixtures thereof.

13. Process according to claim 1 wherein the at least one isocyanate-bearing compound is a polyisocyanate selected from the group comprising: methylene diphenyl diisocyanate in the form of its 2,4′-, 2,2′- and 4,4′-isomers and mixtures thereof, the mixtures of methylene diphenyl diisocyanates and oligomers thereof, or their derivatives having a urethane, isocyanurate, allophonate, biuret, uretonimine, uretdione and/or iminooxadiazinedione groups and mixtures thereof; toluene diisocyanates and isomer mixtures thereof; tetramethylxylene diisocyanate; 1,5-naphtalenedii socyanate; p-phenylenediisocyanate; tolidine diisocyanate; or mixtures of these organic polyisocyanates, and mixtures of one or more of these organic polyisocyanates with methylene diphenyl diisocyanate in the form of 2,4′-, 2,2′- and 4,4′-isomers and mixtures thereof, the mixtures of methylene diphenyl diisocyanate and oligomers thereof.

14. Process according to claim 1 wherein the polysaccharide derivative is in the form of granules, wherein the granules have a particle size distribution wherein the D50 is at most 1.0 mm, wherein D50 is defined as the particle size for which fifty percent by weight of the particles has a size lower than the D50 according to standard ISO 13320:2009.

15. Process according to claim 1 wherein the water content in the at least one polysaccharide is below 6 wt.

16. Process according to claim 1 wherein the mixing in the dispersion step is performed for at least 90 minutes and the stable dispersion of derivatized polysaccharide is having an NCO value in the range 6-25%.

17. Process according to claim 1 wherein the stable dispersion is containing 5-20 wt % derivatized polysaccharide based on the total weight of the stable dispersion.

18. (canceled)

19. An article produced using the stable dispersion of claim 1, wherein the article is selected from packaging, films, foams, composites, adhesives, coatings, textiles, sealants, rheology modifiers, paints, chromatography packing
